(19) United States
(12) Patent Application Publication
(10) Pub. No.: US 2007/0250449 A1
(43) Pub. Date: Oct. 25, 2007

(54) System and method for automated friend-to-friend delivery item

(76) Inventor: Lyn Seidler, Washington, DC (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/713,618

(22) Filed: Mar. 5, 2007

Related U.S. Application Data
(63) Continuation of application No. 11/485,985, filed on Jul. 14, 2006, now abandoned.
Application No. 11/485,985 is a continuation of application No. 11/271,754, filed on Nov. 14, 2005, now abandoned.
(60) Provisional application No. 60/626,977, filed on Nov. 12, 2004.

(51) Int. Cl. H04L 9/32

(52) U.S. Cl. 705/60

(57) ABSTRACT

A system and method for creating and billing for a friend-to-friend delivery item. The friend-to-friend system authenticates a user, generates a friend-to-friend permit based on permit information received from the user, receives payment account identification information, and generates a friend-to-friend delivery item based on the permit and the information received from the user. The friend-to-friend system also automatically bills a user based on the number of delivery items processed by the delivery service.

### RELATED APPLICATION

This application claims priority benefit based on U.S. provisional application No. 60/626,977, filed on Nov. 12, 2004, the technical disclosure of which is hereby incorporated by reference.

### TECHNICAL FIELD

This invention relates generally to a system and method for creating friend-to-friend delivery items and billing the creators of the items for those items processed by a delivery service.

### BACKGROUND

A friend-to-friend delivery item may be a mailpiece, such as a card or a letter, that is created by a third party and sent by a sender to a recipient and in which the third party prepays for the postage. For example, an advertiser may create a mailpiece and supply it to customers (senders) who may send the mailpiece to recipients, such as friends, family members, or business associates of the customers. The mailpieces are preprinted and the postage is prepaid by the advertiser. The mailpiece may, for example, promote special offers or messages from the advertiser. The customers can address the postcards to the recipients and, in many cases, the customers may add a short note explaining why they are forwarding the mailpiece. Because the postage has been prepaid by the advertiser, the customer can simply drop the mailpiece in the mail. The mailpiece is then processed by mail processing equipment at a mail processing facility of a service provider, such as, for example, the United States Postal Service™ (USPS™).

Presently, creating and paying for friend-to-friend delivery items is cumbersome, time consuming, and expensive. To create a friend-to-friend delivery item, such as a mailpiece, a creator must first physically travel to the local post office to apply for a permit and set up a payment account, and then contact postal headquarters to obtain the numbers for an optically-readable code identifying the item and the font for printing the code. The creator must then design the mailpiece according to format specifications set forth by USPS™ in the Domestic Mail Manual and have the piece reviewed by local postal personnel. Postal headquarters must semiannually prepare billing statements of mailpieces that are processed by the delivery service and then manually bill a customer based on these tracking reports.

Therefore, it is desirable to provide an automated friend-to-friend system that allows a user to automatically and efficiently create and pay for friend-to-friend delivery items, generate tracking reports, and bill a user.

### SUMMARY

Consistent with the invention, there is provided a computer-implemented method for automatically creating a friend-to-friend delivery item file and billing for a processed friend-to-friend delivery item. The method includes authenticating a user; prompting a user to establish an account with a payment system; receiving account identification information from the payment system; receiving permit information from the user; generating a friend-to-friend permit based on the permit information; receiving design information for designing markings for a friend-to-friend delivery item; and generating markings for the friend-to-friend delivery item based on the friend-to-friend permit and the design information.

Also provided is a system for creating a friend-to-friend delivery item and for automatically billing for the processed friend-to-friend delivery item. The system includes a registration system for authenticating a user. The system also includes an application server for authenticating a user; prompting a user to establish an account with a payment system; receiving account identification information from the payment system; receiving permit information from the user; generating a friend-to-friend permit based on the permit information; receiving design information for designing markings for a friend-to-friend delivery item; and generating markings for the friend-to-friend delivery item based on the friend-to-friend permit and the design information. The system further includes a database server for storing information relating to the friend-to-friend delivery item.

Also provided is a computer-readable medium containing instructions to configure a data processor to perform a method for creating and billing a friend-to-friend delivery item. The computer-readable medium includes instructions to configure a data processor for authenticating a user; prompting a user to establish an account with a payment system; receiving account identification information from the payment system; receiving permit information from the user; generating a friend-to-friend permit based on the permit information; receiving design information for designing markings for a friend-to-friend delivery item; and generating markings for the friend-to-friend delivery item based on the friend-to-friend permit and the design information.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and subcombinations of the features described in the detailed description.

### BRIEF DESCRIPTION OF THE DRAWINGS

FIG. 1 depicts a block diagram of an exemplary system environment, consistent with the present invention;

FIG. 2 depicts a block diagram of an exemplary application server, consistent with the present invention;

FIG. 3 depicts a flow diagram of an exemplary registration process, consistent with the present invention;

FIG. 4 depicts a flow diagram of an exemplary payment process, consistent with the present invention;

FIG. 5 depicts a flow diagram of an exemplary permit process, consistent with the present invention;

FIG. 6 depicts a flow diagram of an exemplary design process, consistent with the present invention;

FIG. 7 depicts an embodiment of postal markings for a friend-to-friend delivery item, consistent with the present invention;

FIG. 8 depicts a flow diagram of an exemplary download process, consistent with the present invention; and

FIG. 9 depicts a flow diagram of a billing process, consistent with the present invention.

### DETAILED DESCRIPTION

Reference will now be made in detail to an exemplary embodiment consistent with the invention, an example of which is illustrated in the accompanying drawings. Wherever possible, the same reference numbers will be used throughout the drawings to refer to the same or like parts. Although embodiments are described with respect to a mail system, the invention is not so limited. Rather, the invention may be employed with many types of delivery systems.

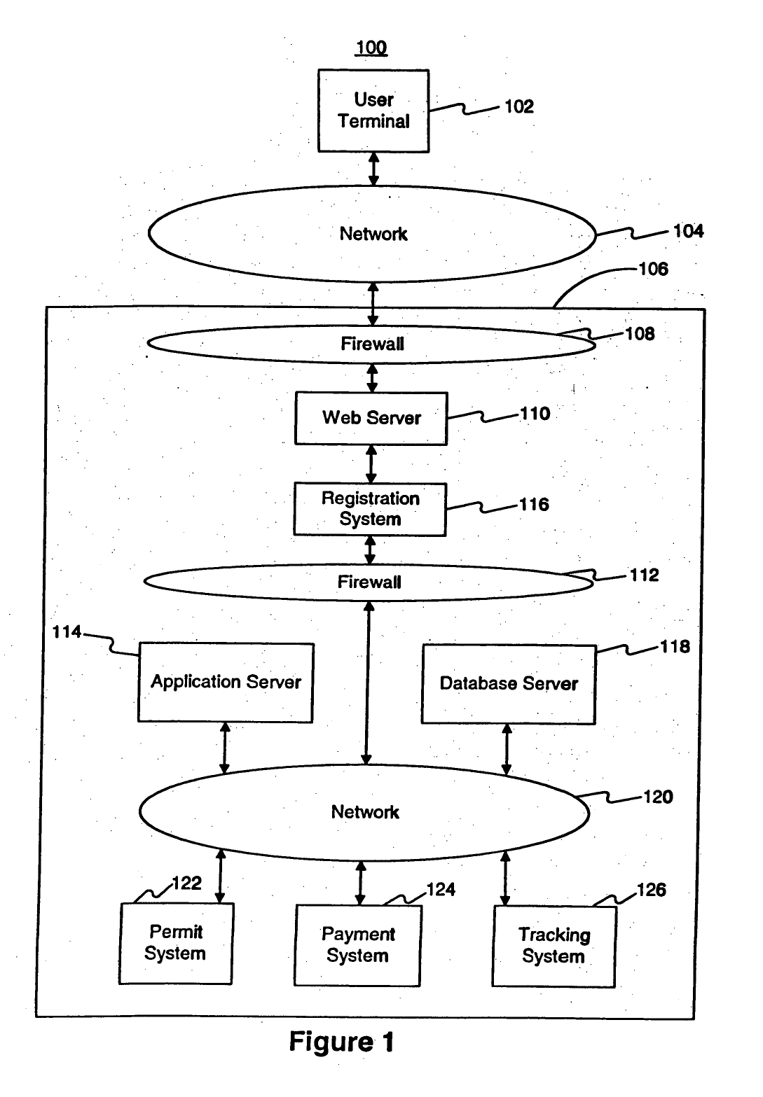

FIG. 1 depicts a block diagram of an exemplary system environment 100, consistent with the present invention. As illustrated, a user terminal 102 connects to a network 104. Network 104 may be implemented through any suitable combination of wired and/or wireless communication networks. For example, network 104 may be implemented through a wide area network (WAN), local area network (LAN), an Intranet and/or the Internet. Additionally, network 104 may utilize any suitable type of network protocol. For ease of explanation, network 104 will be hereinafter referred to as Internet 104 and will be assumed to use Transport Control Protocol/Internet Protocol (TCP/IP). User terminal 102 may be any appropriate type of user terminal and may be, for example, a user computer or data processor executing a Web browser type program, such as Microsoft Internet Explorer or Apple Safari. Accordingly, user terminal 102 may include a processor, memory, storage, and an interface for connecting to Internet 104.

Additionally, an automated friend-to-friend system 106 connects to Internet 104. As illustrated, automated friend-to-friend system 106 includes a Web server 110 connected to Internet 104 via a firewall 108. In one embodiment, automated friend-to-friend system 106 communicates with user terminal 102 through Web server 110. Web server 110 may be any type of data processor or computer and may include, for example, a processor, memory, storage, and interfaces. Web server 110, in one embodiment, stores a set of Web pages for interfacing with user terminal 102. User terminal 102 sends information to Web server 110, which may then send the information to other systems and subsystems of automated friend-to-friend system 106, such as a registration system 116 or an application server 114. Similarly, to send information to user terminal 102, the systems and subsystems of automated friend-to-friend system 106 send information to Web server 110, which formats the information and sends it to user terminal 102.

Registration system 116 functions to register and authenticate users of automated friend-to-friend system 106. In one embodiment, registration system 116 may include at least one data processor, or computer, and at least one database for storing user authentication data. Registration system 116 connects to a network 120 through a firewall 112. Firewalls 108 and 112 may be any appropriate type of firewall, such as, for example, commercially available firewalls. Once a user has been authenticated, registration system 116 authorizes user terminal 102 to communicate with application server 114 through Web server 110 and network 120.

Network 120 connects the systems associated with automated friend-to-friend system 106. Network 120 may be, for example, an internal network for an organization providing postal delivery services. For ease in explanation, network 120 will be hereinafter referred to as Intranet 120. One of skill in the art will recognize, however, that Intranet 120, in other embodiments, may be any type of communication medium or channel and may include, alone or in any suitable combination, a telephony-based network, a LAN, a WAN, a dedicated Intranet, the Internet, a wireless network, or a bus. Moreover, in one embodiment, network 104 may include or be a part of a communications network, such as the Internet or a corporate Intranet that is compatible with a networking protocol, such as TCP/IP.

A database server 118 stores data associated with users of automated friend-to-friend system 106. Database server 118 may store information that can be accessed through a conventional database protocol, such as Structured Query Language (SQL). Although not depicted in FIG. 1, one of ordinary skill in the art will recognize that database server 118 may include a computer or data processor for accessing, searching, and/or processing stored information. Further, one of ordinary skill in the art will recognize that database server 118 may be implemented using a plurality of databases and may be connected to other components of friend-to-friend system 106 via Intranet 120.

A permit system 122 functions to authorize a friend-to-friend permit. Permit system 122 may be implemented as a computer or network of computers and a database or set of databases that may provide a permit form to solicit information from a user, receive information associated with a user's request to apply for a friend-to-friend permit, process the information, and establish a valid friend-to-friend permit account in response. Alternatively, permit system 122 may provide a permit form for a user to print. The user may print the form, enter the information associated with the user's request to apply for a friend-to-friend permit, and mail the completed form to a service provider, such as USPS™. The service provider can establish the permit account. An example of such a system is USPS's PERMIT® system.

A payment system 124 functions to process payments of fees associated with the friend-to-friend system 106. In one embodiment, processing payment of friend-to-friend fees may include debiting a user's account by performing an Electronic Fund Transfer (EFT) on an Automated Clearing House (ACH) account, as is understood by one of skill in the art. An example of payment system 124 is the Centralized Account Processing System (CAPS) used by USPS™. A user must register with payment system 124 to create a payment system account. In one embodiment, payment system 124 automatically performs an EFT on a user's ACH account to pay friend-to-friend fees, as is understood.

A tracking system 126 is provided. Tracking system 126 may be a mail tracking system that identifies and tracks delivery items, such as mailpieces that are processed by mail processing equipment at mail processing facilities, and returns information from the tracked mailpieces to application server 114. Tracking system 126 can include a database that stores tracking information. Tracking information can include information regarding an optically-readable code associated with the friend-to-friend delivery item, such as a PLANET® code used by USPS™, and other data used for billing, such as, for example, the date, time, and/or name of the mail processing facility. In one embodiment, tracking system 126 can be embodied as USPS's CONFIRM® system. Detailed information regarding the CONFIRM® system is disclosed, for example, in USPS™ Publication 432, CONFIRM®: Mail Tracking Information Using PLANET® Code (PUB 432), the entire contents of which are incorporated herein by reference.

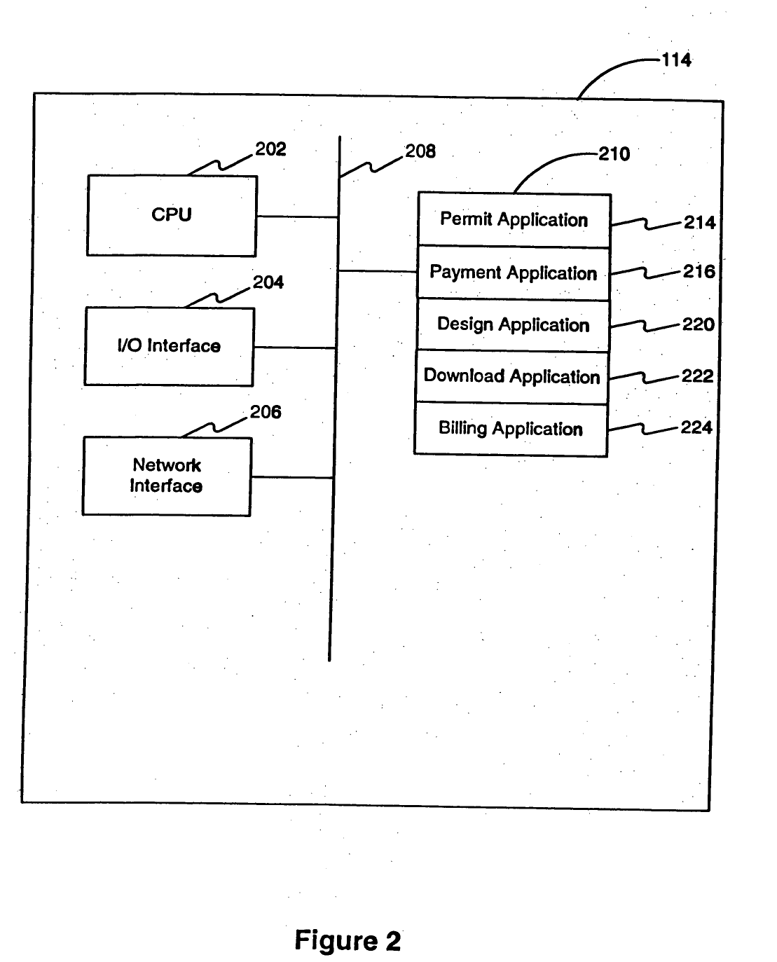

Application server 114 may be embodied as a data processor, such as a computer, that functions to execute friend-to-friend applications. FIG. 2 depicts a block diagram of an exemplary application server 114, consistent with the present invention. Application server 114 includes at least one central processing unit (CPU) 202, an I/O interface 204, a network interface 206, and memory 210. CPU 202 executes instructions associated with the application programs forming application components contained in memory 210. CPU 202 then transmits results to other subsystems in application server 114 over a high-speed interconnect or data bus 208. I/O interface 204 is an interface used to couple application server 114 with devices, such as a keyboard, a mouse, a display device, and any other I/O device useful in operating and managing application server 114, as is understood by one of skill in the art. Network interface 206 is used to communicate with Intranet 120 (FIG. 1).

Memory 210 includes, in one embodiment: a permit application 214 having program instructions that, when executed, receive permit information and generates and stores a friend-to-friend permit; a payment application 216 having program instructions that, when executed, receive and process payment information; a design application 220 having program instructions that, when executed, receive design information, generate a friend-to-friend delivery item, store the friend-to-friend delivery item, and provide the friend-to-friend delivery item to the user; a download application 222 having program instructions that, when executed, retrieve a stored delivery item and send it to a user for downloading and printing; and a billing application 224 having program instructions that, when executed, receive billing information from tracking system 126, send it to payment system 124 to debit a user's account, and store it in database server 118.

Referring to FIG. 1, a user may initiate a request to create a friend-to-friend delivery item by contacting Web server 110 using a Web browser executing on user terminal 102. For example, a user may select to connect to Web server 110 using the Web browser by entering a Uniform Resource Locator (URL) identifying Web server 110 (e.g., www.usps.com). In response, user terminal 102 may contact the Web server 110 via Internet 104, where firewall 108 is programmed to permit information regarding a Web page for the Web server 110 to be sent to the user terminal 102. In response, a Web page is displayed on user terminal 102 using the Web browser.

In one embodiment, Web server 110 sends a Web page prompting a user to log into the friend-to-friend system. For example, the page may include a button prompting a user to log in. Web server 110 may also, in one embodiment, send a Web page or Web pages providing information to a user about the friend-to-friend system, such as in the form of Frequently Asked Questions. Such a Web page or Web pages may be provided through a link or links, as is understood by one of skill in the art.

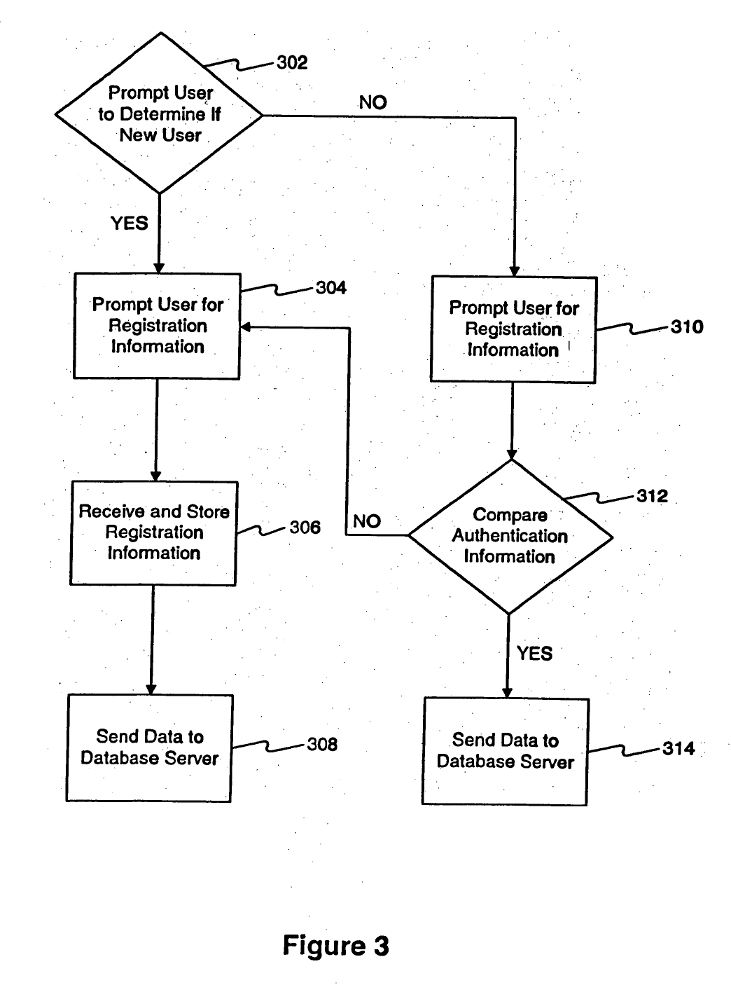

In one embodiment, a user must register before the user can access additional friend-to-friend services. FIG. 3 depicts a flow diagram of an exemplary registration process, consistent with the present invention. The flow diagram will be described with reference to the embodiment of the system depicted in FIG. 1 and application server 114 depicted in FIG. 2. First, Web server 110 sends user terminal 102 a Web page to determine (step 302) if the user is a new user. If the user is a new user, Web server 110 prompts (step 304) the user to submit registration information, which may include identification information, such as the user's name and address, the user's company name, and/or the user's e-mail address. Web server 110 may also prompt the user for information for authentication, such as a user name and a password. Web server 110 may receive the registration information from user terminal 102 and send it to registration system 116. Registration system 116 receives and stores (step 306) the registration information including the authentication information. In addition, registration system 116 may send (step 308) user identification data from the registration information, such as the user's name and address and the company name, to database server 118.

If the user is not a new user, Web server 110 may prompt (step 310) the user for authentication information, such as, for example, a user name and password. Web server 110 sends the authentication information to registration system 116. Registration system 116 compares (step 312) the received authentication information with authentication information stored in its database to determine if the user is a valid user of automated friend-to-friend system 106. If authentication fails, registration system 116 may, through Web server 110, prompt (step 304) the user to enter registration information. If authentication is successful, registration system 116 may authorize (step 314) the user to access friend-to-friend services provided by application server 114.

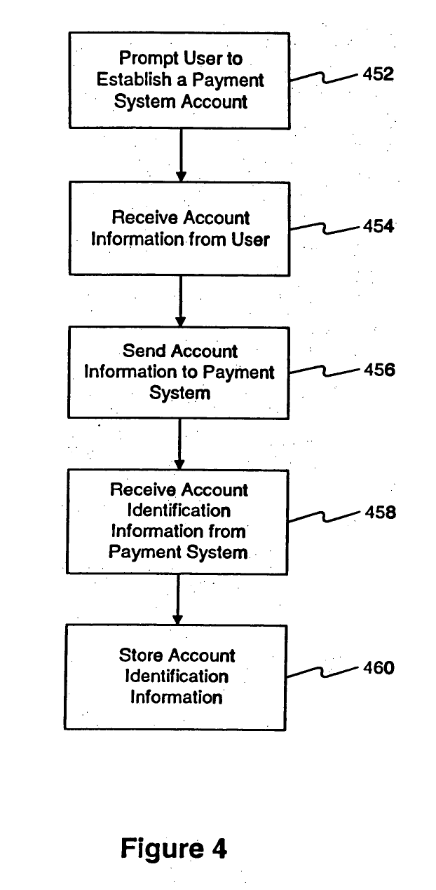

After a user has successfully registered and been authenticated, the user can access additional features of the friend-to-friend system. For example, a user can establish an account with payment system 124. FIG. 4 depicts a flow diagram of an exemplary payment process, consistent with the present invention. The flow diagram will be described with reference to the embodiment of the system depicted in FIG. 1 and application server 114 depicted in FIG. 2. In one embodiment, Web server 110 sends user terminal 102 a Web page to prompt (step 452) a user to establish an account with payment system 124. In one embodiment, the Web page prompts a user to download forms to fill out with account information and send by any suitable means, including by post or by electronic mail, to a service provider, such as USPS™. Account information may include identification information, such as the user's name and address, the user's company name, and/or the user's e-mail address. In another embodiment, a user may establish an account with payment system 124 by sending account information from user terminal 102 to Web server 110, which forwards it to application server 114. Upon receipt of the account information, CPU 202 of application server 114 executes payment application 216. Payment application 216 receives (step 454) the account information and sends (step 456) it to payment system 124, which establishes the user's account. When the account is successfully established, payment application 216 receives (step 458) account identification information from payment system 124. Account identification information may include an account number and customer identification information. Payment application 216 stores (step 460) account identification information in database server 118.

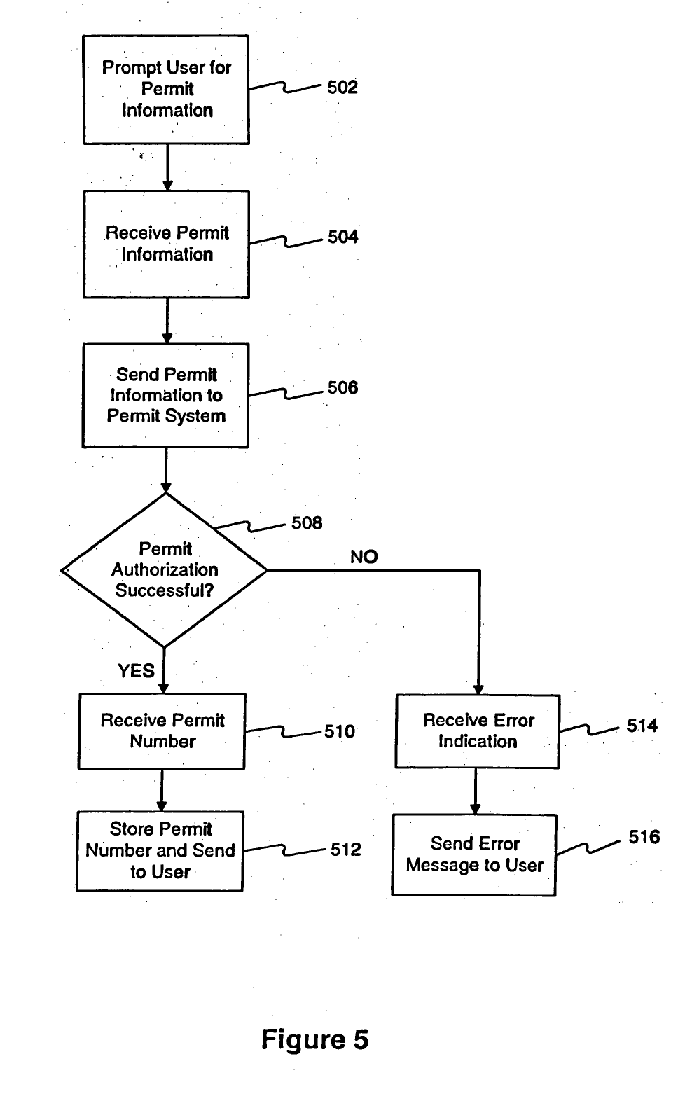

After a user has established a payment account, a user can apply for a friend-to-friend permit. FIG. 5 depicts a flow diagram of an exemplary permit process, consistent with the present invention. The flow diagram will be described with reference to the embodiment of the system depicted in FIG. 1 and application server 114 depicted in FIG. 2. Web server 110 prompts (step 502) a user for permit information. Permit information is any information relating to application for a friend-to-friend permit and may include user identification information, such as the user's name, address, and company name, the ZIP code of the issuing post office, and the type of permit a user would like to purchase.

The user enters the permit information and sends it from user terminal 102 to Web server 110, which forwards it to application server 114. Upon receipt of the permit information, CPU 202 of application server 114 executes permit application 214. Permit application 214 receives (step 504) the permit information. Permit application 214 then sends (step 506) the permit information to permit system 122. If permit authorization from permit system 122 was successful (step 508), permit application 214 receives (step 510) a valid friend-to-friend permit number, stores it in database server 118, and sends (step 512) it to user terminal 102 through Web server 110. If permit authorization was unsuccessful (step 508), permit application 214 receives (step 514) an error indication from permit system 122 and sends (step 516) an error message identifying the error to user terminal 102 through Web server 110. Permits may include fees, such as an initial application fee and periodic fees. Permit application 214 may automatically pay these fees by sending an indication to payment system 124 to debit the user's payment system account.

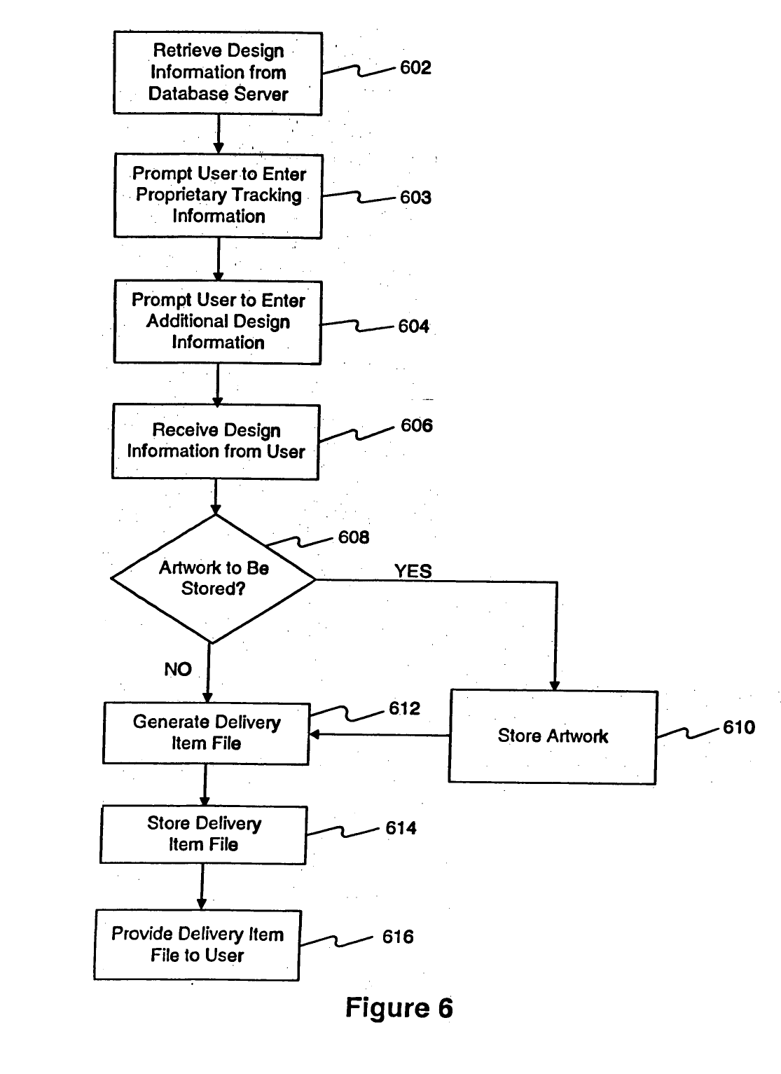

After a user has received a permit, a user can design a friend-to-friend delivery item. FIG. 6 depicts a flow diagram of an exemplary design process, consistent with the present invention. The flow diagram will be described with reference to the embodiment of the system depicted in FIG. 1 and application server 114 depicted in FIG. 2. Upon receiving a user's request to design a friend-to-friend delivery item, CPU 202 of application server 114 executes design application 220. Design application 220 may retrieve (step 602) design information from the database server 118 to generate the friend-to-friend delivery item. For example, design application 220 may retrieve the user's company name and address and permit number. Design application 220 may also retrieve artwork stored by the user as described below. Design application 220 may use this information to design the friend-to-friend delivery item by, for example, printing the permit number and company information on the delivery item.

Web server 110 may prompt (step 603) a user to enter proprietary tracking code information. Proprietary tracking code information can include information, such as a series of digits, relating to an optically-readable code, such as a PLANET® code, for tracking the friend-to-friend delivery item as described below. For example, a user may enter a series of digits for identifying a delivery item having a particular design. Using these series of digits, the user can determine from tracking reports the volume of delivery items having the corresponding design that are delivered as described below. In one embodiment, design application 220 can receive the proprietary tracking code information and send it to tracking system 126. Tracking system 126 returns information, which may be a series of digits, that design application 220 can convert into the optically-readable code, such as a PLANET® code, for tracking the friend-to-friend delivery item as described below. Detailed information regarding the PLANET® bar code system is disclosed, for example, in USPS™ Publication 432, CONFIRM®: Mail Tracking Information Using PLANET® Code (PUB 432), the entire contents of which are incorporated herein by reference.

Web server 110 may also prompt (step 604) a user to enter additional design information, which may include the card or letter type, the size of the friend-to-friend card or letter, the font type and size, and artwork, such as a company's logo. In one embodiment, a user may upload artwork, which may be in any suitable electronic format, such as a jpeg or bitmap, as is understood by one of skill in the art. In one embodiment, if the user requests to store the artwork (step 608), design application 220 receives (step 606) the user's artwork from Web server 110 and stores (step 610) it in database server 118.

After retrieving the design information from database server 118 and from the user, design application 220 can generate (step 612) a friend-to-friend delivery item file according to friend-to-friend specifications. An example of friend-to-friend specifications can be found in the Domestic Mail Manual from USPS™, which is hereby expressly incorporated by reference. Design application 220 can include an optically-readable code, such as a PLANET® code, that uniquely identifies the delivery item and can be used by tracking system 126 to identify and track the delivery item during processing. In addition, design application 220 can generate a friend-to-friend delivery item file including additional bar codes or additional unique optically-readable codes, such as the PLANET® code or the POSTNET® code currently in use by USPS™. An example of such a code is a Facing Identification Mark (FIM) code that may alert mail processing equipment to sort the friend-to-friend delivery items based on the postage requirements. Postage requirements refer to the amount of postage necessary to delivery the delivery item. Mail processing equipment refers to equipment that processes a friend-to-friend delivery item when it is returned, which may perform a function on the friend-to-friend delivery item when it reads a certain code. An example of such mail processing equipment is the Advanced Facer Canceller System (AFCS) used by USPS™.

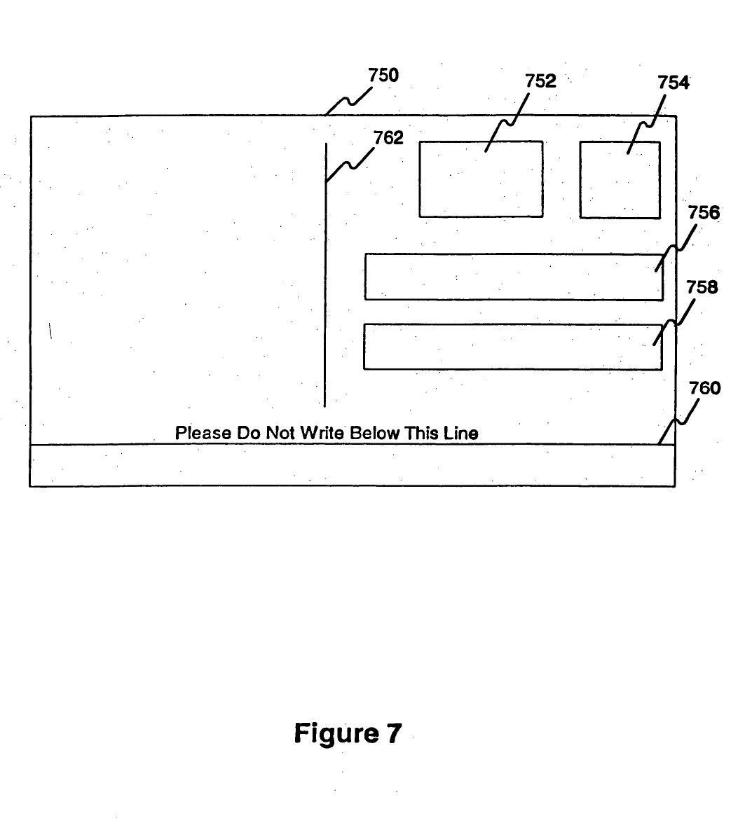

A friend-to-friend delivery item file consists of a file in any suitable design format, such as, for example, the portable document format (pdf) used by Adobe® Reader®. In one embodiment, the friend-to-friend delivery item file includes the design for the friend-to-friend delivery item according to specifications, such as those found in the Domestic Mail Manual from USPS™, and the user can simply print out the delivery item on suitable paper. In another embodiment, the friend-to-friend delivery item file includes only the postal markings for a friend-to-friend delivery item. A user can print out these postal markings on suitable paper and design the rest of the card offline. In such an embodiment, the user must seek approval of the design from a design analyst, such as a Mailpiece Design Analyst affiliated with USPS™. FIG. 7 depicts an embodiment of postal markings for a friend-to-friend delivery item 750, consistent with the present invention. An FIM code 752 is provided to alert mail processing equipment to sort the friend-to-friend delivery item based on postage requirements. A postage area 754 is provided for a customer to provide postage or to indicate that postage has already been paid; a friend-to-friend delivery item permit indicia 756 is provided for identifying a valid friend-to-friend permit; an optically-readable code 758 is provided to track the delivery item; a horizontal line and the message “Please Do Not Write Below This Line” 760 is provided to prevent customers from writing in an area provided for an optically-readable code, such as a POSTNET® code used by mail processing equipment; and a vertical line 762 is provided to separate the portion of the delivery item for customers to write messages.

Returning to FIG. 6, after generating a friend-to-friend delivery item file, in one embodiment, design application 220 can then store (step 614) the friend-to-friend delivery item file in database server 118 and provide (step 616) the file to user terminal 102 through Web server 110. In one embodiment, a user can download the friend-to-friend delivery item file to user terminal 102 through Internet 104. In other embodiments, design application 220 can electronically mail the friend-to-friend delivery item file to an e-mail address provided by the user. The user, through user terminal 102, may also provide a name for the delivery item file, which design application 220 can associate with the stored delivery item file for subsequent reference by the user.

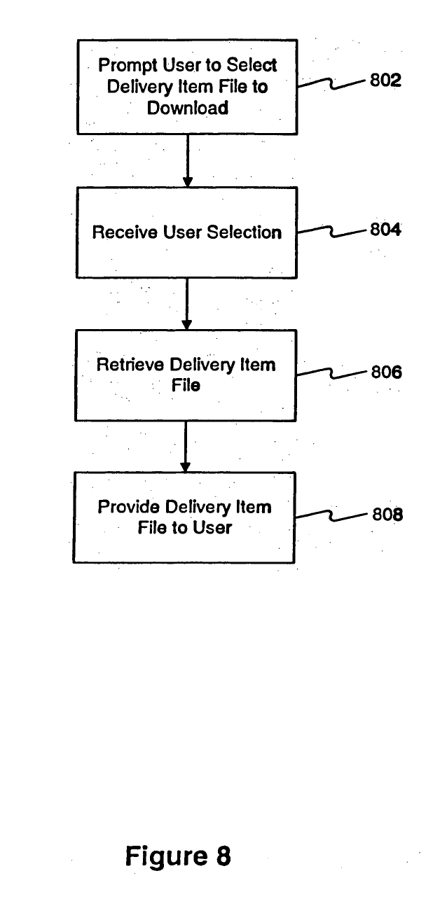

Friend-to-friend system 106 may allow a user to download a saved friend-to-friend delivery item file. Upon receiving the user's request to download a delivery item, CPU 202 of application server 114 executes download application 222. FIG. 8 depicts a flow diagram of an exemplary download process, consistent with the present invention. The flow diagram will be described with reference to the embodiment of the system depicted in FIG. 1 and application server 114 depicted in FIG. 2. Download application 222, through Web server 110, prompts (step 802) a user to select the delivery item file to download. Upon receiving (step 804) the selection, download application 222 retrieves (step 806) the selected delivery item file from database server 118 and provides (step 808) it to user terminal 102. In one embodiment, a user can download the friend-to-friend delivery item file to user terminal 102 through Internet 104. In other embodiments, download application 222 can electronically mail the friend-to-friend delivery item to an e-mail address provided by the user.

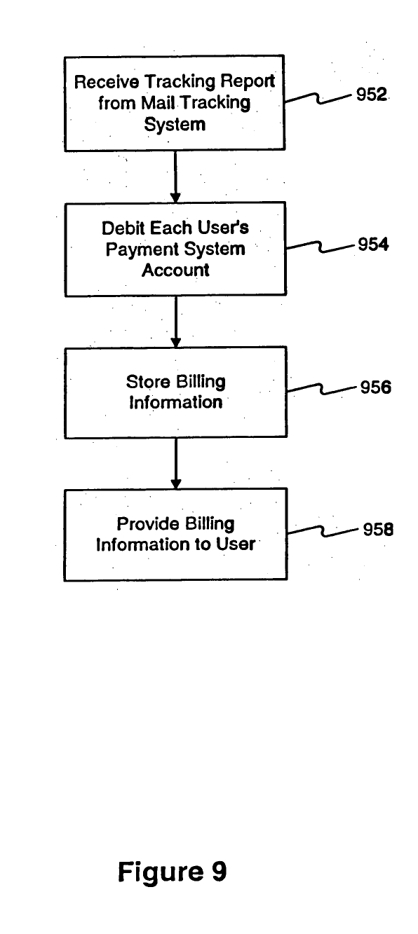

Once a delivery item, such as a mailpiece, enters the delivery stream, friend-to-friend system 106 can automatically track each delivery item and bill the user accordingly. FIG. 9 depicts a flow diagram of a billing process, consistent with the present invention. The flow diagram will be described with reference to the embodiment of the system depicted in FIG. 1 and application server 114 depicted in FIG. 2. After creating a delivery item, a user can then distribute the delivery items to senders of friend-to-friend delivery items, such as, for example, customers.

In one embodiment, these senders may send the delivery items through the delivery stream to recipients. In one embodiment, the mail processing equipment at the destination mail processing facility may read the optically-readable codes, such as the PLANET® and/or POSTNET® codes, that uniquely identify the delivery item. The mail processing equipment then sends the delivery item identification information to tracking system 126. At the end of a period of time, for example, one day, tracking system 126 may calculate the number of delivery items processed for each user and generate a tracking report. The report may include, for example, the volume of delivery items delivered, the dates that each delivery item was delivered, the ZIP code for each sender, and the ZIP code for each recipient. The tracking system 126 may send the report to application server 118. Upon receipt of the tracking report, CPU 202 of application server 114 executes billing application 224. Billing application 224 receives (step 952) the tracking report and sends an indication to payment system 124 to debit (step 954) each user's account based on the number of that user's delivery items processed. Billing application 224 may also store (step 956) billing information from the tracking report in database server 118 and provide (step 958) the billing information to user terminal 102 through Web server 110. Billing information can include information from the tracking report, such as the volume of delivery items delivered and the dates of delivery. In addition, the billing information can include the proprietary tracking information for each delivery item.

While certain features and embodiments of the invention have been described, other embodiments of the invention will be apparent to those skilled in the art from consideration of the specification and practice of the embodiments of the invention disclosed herein. Furthermore, although embodiments of the present invention have been described as being associated with data stored in memory and other storage mediums, one skilled in the art will appreciate that these aspects can also be stored on or read from other types of computer-readable media, such as secondary storage devices, like hard disks, floppy disks, or a CD-ROM, a carrier wave from the Internet, or other forms of RAM or ROM. Further, the steps of the disclosed methods may be modified in any manner, including by reordering steps and/or inserting or deleting steps, without departing from the principles of the invention.

It is intended, therefore, that the specification and examples be considered as exemplary only, with a true scope and spirit of the invention being indicated by the following claims and their full scope of equivalents.

What is claimed is:

1. A computer-implemented method for creating and billing a friend-to-friend delivery item comprising:
authenticating a user;
prompting a user to establish an account with a payment system;
receiving account identification information from the payment system;
receiving permit information from the user;
generating a friend-to-friend permit based on the permit information;
receiving design information for designing a friend-to-friend delivery item; and
generating the friend-to-friend delivery item based on the friend-to-friend permit and the design information.

2. The method of claim 1, further comprising creating a billing report containing billing information, including the number of delivery items created by the user processed by a postal facility.

3. The method of claim 2, further comprising automatically debiting the payment system account of a user, based on the number of delivery items processed.

4. The method of claim 1, wherein authenticating comprises implementing a registration process.

5. The method of claim 4, further comprising storing user identification data for subsequent access.

6. The method of claim 1, further comprising storing account identification information for subsequent access.

7. The method of claim 1, further comprising storing permit information for subsequent access.

8. The method of claim 1, further comprising creating the friend-to-friend delivery item according to USPS™ specifications.

9. The method of claim 8, further comprising incorporating artwork into the friend-to-friend delivery item.

10. The method of claim 1, further comprising storing an image of the friend-to-friend delivery item for subsequent access.

11. The method of claim 1, further comprising sending the friend-to-friend delivery item in a format such that the user can download and/or print the response piece.

12. A system for creating a friend-to-friend delivery item and for automatically billing processed friend-to-friend delivery item comprising:
a registration system for:
authenticating a user;
an application server for:
prompting a user to establish an account with a payment system;
receiving account identification information from the payment system;
receiving permit information from the user generating a friend-to-friend permit based on the permit information;
receiving design information for designing a friend-to-friend delivery item; and
generating the friend-to-friend delivery item based on the friend-to-friend permit and the design information; and
a database server comprising software for:
storing information relating to the friend-to-friend delivery item.

13. The system of claim 12, wherein the application server further comprises a component for creating a billing report containing billing information, including the number of delivery items created by the user processed by a postal facility.

14. The system of claim 13, further comprising a component for automatically debiting the user's payment system account based on the number of delivery items processed.

15. The system of claim 12, wherein the database server further comprises a component for storing user identification data for subsequent access.

16. The system of claim 12, wherein the database server further comprises a component for storing account identification information for subsequent access.

17. The system of claim 12, wherein the database server further comprises a component for storing permit information for subsequent access.

18. The system of claim 12, wherein the application server further comprises a component for creating the friend-to-friend delivery item according to USPS™ specifications.

19. The system of claim 12, wherein the application server further comprises a component for incorporating artwork into the friend-to-friend delivery item.

20. The system of claim 12, wherein the database server further comprises a component for storing an image of the friend-to-friend delivery item for subsequent access.

21. The system of claim 12, wherein the application server further comprises a component for sending the friend-to-friend delivery item in a format such that the user can download and/or print the response piece.

22. A computer-readable medium containing instructions to configure a data processor to perform a method for creating and billing a friend-to-friend delivery item, wherein the method comprises:
authenticating a user;
prompting a user to establish an account with a payment system;
receiving account identification information from the payment system;
receiving permit information from the user;
generating a friend-to-friend permit based on the permit information;
receiving design information for designing a friend-to-friend delivery item; and
generating the friend-to-friend delivery item based on the friend-to-friend permit and the design information.

23. The computer-readable medium of claim 22, wherein the method comprises creating a billing report containing billing information, including the number of delivery items created by the user processed by a postal facility.

24. The computer-readable medium of claim 22, wherein the method comprises automatically debiting the user's payment system account based on the number of delivery items processed.

25. The computer-readable medium of claim 22, wherein authenticating comprises implementing a registration process.

26. The computer-readable medium of claim 25, wherein the method comprises storing user identification data for subsequent access.

27. The computer-readable medium of claim 22, wherein the method comprises storing account identification information for subsequent access.

28. The computer-readable medium of claim 22, wherein the method comprises storing permit information for subsequent access.

29. The computer-readable medium of claim 22, wherein the method comprises creating the friend-to-friend delivery item according to USPS™ specifications.

30. The computer-readable medium of claim 29, wherein the method comprises incorporating artwork into the friend-to-friend delivery item.

31. The computer-readable medium of claim 22, wherein the method comprises storing an image of the friend-to-friend delivery item for subsequent access.

32. The computer-readable medium of claim 22, wherein the method comprises sending the friend-to-friend delivery item in a format such that the user can download and/or print the response piece.
